(19) United States
(12) Patent Application Publication
(10) Pub. No.: US 2008/0249899 A1
(43) Pub. Date: Oct. 9, 2008

(54) System and Method for Inventory

(76) Inventor: Gabriel G. Nasser, Dubai (AE)

Correspondence Address: GOODWIN PROCTER LLP;PATENT ADMINISTRATOR, EXCHANGE PLACE, BOSTON, MA, 02109-2881, US

(21) Appl. No.: 12/055,987

(22) Filed: Mar. 26, 2008

Related U.S. Application Data
(60) Provisional application No. 60/921,965, filed on Apr. 5, 2007.
(60) Provisional application No. 61/028,757, filed on Feb. 14, 2008.

(51) Int. Cl. G06Q 10/00; G06F 17/30

(52) U.S. Cl. 705/28

(57) ABSTRACT

Systems and methods for conducting an inventory of items at a retail or wholesale site include affixing RFID transponders to items and a computer-assisted inventory procedure determines which items are present at the retail or wholesale location, and the locations of these items, and provides instructions to operators as to how to proceed with the inventory.

### CROSS-REFERENCE TO RELATED APPLICATIONS

This application claims priority to and the benefits of U.S. provisional patent application Ser. Nos. 60/921,965 and 61/028,757, filed on Apr. 5, 2007, and Feb. 14, 2008, respectively, the entire disclosures of which are incorporated herein by reference.

### TECHNICAL FIELD

This invention relates to performing inventory of retail and wholesale items.

### BACKGROUND INFORMATION

Even with today's technology, it frequently is not convenient or efficient for retail and wholesale sites to track their inventory. In some cases, for example with respect to jewelry stores, a site may have thousands of pieces, with each piece having high value, and yet, it may be difficult to know where a particular item is, or whether it is even at the retail or wholesale site.

### SUMMARY OF THE INVENTION

In general, in one aspect, a method for conducting an inventory of items at a retail or wholesale site includes affixing RFID transponders (also referred to as tags), for example in the form of labels or hard case enclosures, to items. A computer-assisted inventory procedure may then be conducted, for example at regular intervals, to determine which items are present at the retail or wholesale location, and the locations of these items.

For example, in one embodiment, a method for monitoring inventory in a retail or wholesale site includes conducting regular inventory procedures in which one or more human operators each have a mobile device that are used to verify the presence of the items. The mobile devices may (for example, by communicating with a host computer) determine what items are present at a location within the retail or wholesale site. The mobile devices and/or the host computer may direct the human operator(s) to particular locations within the retail or wholesale site, to efficiently interrogate all of the RFID transponders associated with the items. The mobile devices and/or the host computer may provide indications of any inventory items not yet accounted for, as well as information that may assist the human operators in finding those remaining items. The mobile devices and/or the host computer may provide instructions to move to another location within the retail or wholesale site when all items at a particular location within the retail or wholesale site have been accounted for.

In some embodiments, the technique is particularly suited for use in jewelry stores in that it allows a retail or wholesale site operator to quickly and accurately record attributes of jewelry items and provides indications of the attributes to the human operators to help them more efficiently identify each item. Attributes may include (but are not limited to) brand, article type, supplier, color, metal, stone, country of origin, finish type, mounting, size, purity, design, and karat.

In general, in another aspect, a method for conducting an inventory of items at a retail or wholesale site includes a human operator moving a mobile device to a first location within a retail or wholesale site. The mobile device has or includes an RFID interrogator that allows it to interrogate RFID transponders. The RFID transponders are affixed to inventory items. The RFID transponders also may be affixed, or placed at specific locations within the retail or wholesale site. For example, a transponder may be affixed to a particular display case, and another transponder may be affixed to another display case, and yet another transponder affixed to a storage tray. Locations within a retail or wholesale site may include (but are not limited to) one or more display fixtures, cabinets, trays, safes, shelves, drawers, and wall displays. A mobile device or host computer may instruct a human operator to move to a particular location and/or a mobile device or host computer may simply wait for a human operator to bring the mobile device to a location of his choosing.

The mobile device, and more specifically, the RFID interrogator on the mobile device and/or a standalone mobile RFID interrogator, interrogate the RFID transponders, and receive responses from the RFID transponders. Typically, those responses include unique identifiers associated with each respective transponder. The system (e.g., the mobile device and/or a host computer) may determine the location of the mobile device within the retail or wholesale site, and may also determine which items are found generally near that location. The system may filter or otherwise process the information from the RFID transponders. For example, the system may discard duplicate and/or unknown identifiers.

A mobile device and/or a host computer may provide one or more signals (e.g., a message, a sound, a visual indicator, a recorded or generated audio or video message, and so on) upon the occurrence of various events. Those signals may help the human operator(s) to efficiently perform inventory. The events may include items previously at a location are not yet accounted for (i.e., missing), items previously at another location are present at a different location, and/or all items in that location have been accounted for (and so, e.g., an operator may move to a different location).

The method may include, for example, upon the mobile device or host computer providing a signal that all items at a particular location have been accounted for, a human operator moving the mobile device and/or mobile RFID interrogator to another location within the retail or wholesale site (which may be specified by the mobile device or host computer, or selected by a human operator based on a protocol or otherwise), and repeating the method at another location.

The mobile device or host computer may display the number of items not yet accounted for and/or the number of items already accounted for. The mobile device or host computer may display the attributes of items not yet accounted for and/or the attributes of items already accounted for.

The RFID transponders affixed to the items may be tamper-proof, tamper-evident, or neither. For example, in the tamper-proof case, the RFID transponders may be designed such that they do not transmit a signal if they are removed from the items to which they are affixed. As another example, in the tamper-evident case, the RFID transponders may be designed such that they do not transmit a signal, include with their signal an indication of tampering, or leave a physical trace of tampering if they are removed from the items to which they are affixed. The RFID transponders may respond to interrogation by providing a unique identifier (where unique is used to mean substantially unique such that it may be distinguished from the others), and may also be capable of storing and/or providing other information. In some embodiments, the RFID transponders and/or RFID interrogators may be configured such that the transponders are interrogated at close range, such that the transponder is a small distance from an interrogator and/or antenna. This allows for more purposeful interrogation of specific transponders.

In some embodiments, the RFID transponders and/or RFID interrogators may be configured such that the transponders are interrogated at close range, such that the transponder is a small distance from an interrogator and/or antenna. This allows for more purposeful interrogation of specific transponders.

In some embodiments, the transponders and/or interrogators are configured so that an antenna for the interrogator needs to be in relatively close proximity (e.g., 1 cm.-10 cm., 1 cm.-20 cm., 1 cm.-50 cm.) transponders in order to receive a response from them. A human operator, in such embodiments, waves an interrogator antenna (which may be separate from or incorporated into the interrogator and/or the mobile device) over a collection of items. Generally, only the transponders that are relatively near to the antenna respond to the interrogator, and so it is possible, with techniques described here, to correctly identify the location of each item with some precision.

In another aspect, the invention provides a method for managing inventory based on the weights of items (either individually or collectively) and identification tags associated with the items, such as RFID tags. The method includes determining a weight of a collection of items at a first time, and affixing an RFID transponder of known weight to each of the items to facilitate electronic identification of the items. Subsequently, a total weight of a subset of the items is determined and a weight difference between the weights is determined. Based on the difference, a combination of possible missing items is determined and presented to a user to aid in inventory processing. Some of the items may have had the identification tags removed, and others may have been tampered with. In either case, the weight of the collection of items may have changed based on the removal or tampering.

In some embodiments, the RFID tags may be interrogated (in some cases at a time proximate to measuring the weight the second time) and the results compared to listing of expected items to determine which, if any, items are missing.

The mobile devices may be in communication with a host computer via a wired or wireless communication network. The host computer may store inventory data, and provide direction and data analysis to the mobile devices and/or human operators in real-time or in batch mode during the inventory process. In various embodiments, some, all, or none of the inventory processing may be accomplished by the host computer, depending on the processing capability of the mobile devices. Thus, the mobile devices may do some processing or filtering of incoming data, and/or may serve as communication portals to human operators and transponders.

### BRIEF DESCRIPTION OF THE DRAWINGS

FIG. 1 is a block diagram of an implementation according to an embodiment of the invention.

FIG. 2 is a diagram of a retail site that is a jewelry store in which an embodiment of the invention is implemented.

FIG. 3 is an exemplary location layout as displayed in an embodiment of the invention.

FIG. 4 is an illustration of an exemplary transponder as may be used in an embodiment of the invention.

FIG. 5 is an illustration of transponders attached to items of jewelry as may be used in an embodiment of the invention.

FIG. 6 is an illustration of transponders attached to items of jewelry as may be used in an embodiment of the invention.

FIG. 7 is an illustration of an exemplary antenna as may be attached to an interrogator and used in an embodiment of the invention.

FIG. 8 is an illustration of an exemplary antenna of FIG. 7 in a demonstrative use in an embodiment of the invention.

FIG. 9 is another illustration of an exemplary antenna of FIG. 7 in a demonstrative use in an embodiment of the invention.

FIG. 10 is an illustration of an exemplary mobile device with a demonstrative screen display in an embodiment of the invention.

FIG. 11 is an illustration of an example of an interrogator such as may be installed in a mobile device such as the mobile device of FIG. 10.

FIG. 12 is an illustration of a mobile device with an interrogator installed in a demonstrative use in an embodiment of the invention.

FIG. 13 is an exemplary entity relationship diagram in an embodiment of the invention.

FIG. 14 is an exemplary screen display in an embodiment of the invention.

FIG. 15 is an exemplary screen display in an embodiment of the invention.

FIG. 16 is an exemplary screen display in an embodiment of the invention.

FIG. 17 is an exemplary screen display in an embodiment of the invention.

FIG. 18 is an exemplary screen display in an embodiment of the invention.

FIG. 19 is an exemplary screen display in an embodiment of the invention.

FIG. 20 is an exemplary screen display in an embodiment of the invention.

FIG. 21 is an exemplary screen display in an embodiment of the invention.

FIG. 22 is an exemplary screen display in an embodiment of the invention.

FIG. 23 is an exemplary screen display in an embodiment of the invention.

FIG. 24 is an exemplary screen display in an embodiment of the invention.

### DETAILED DESCRIPTION

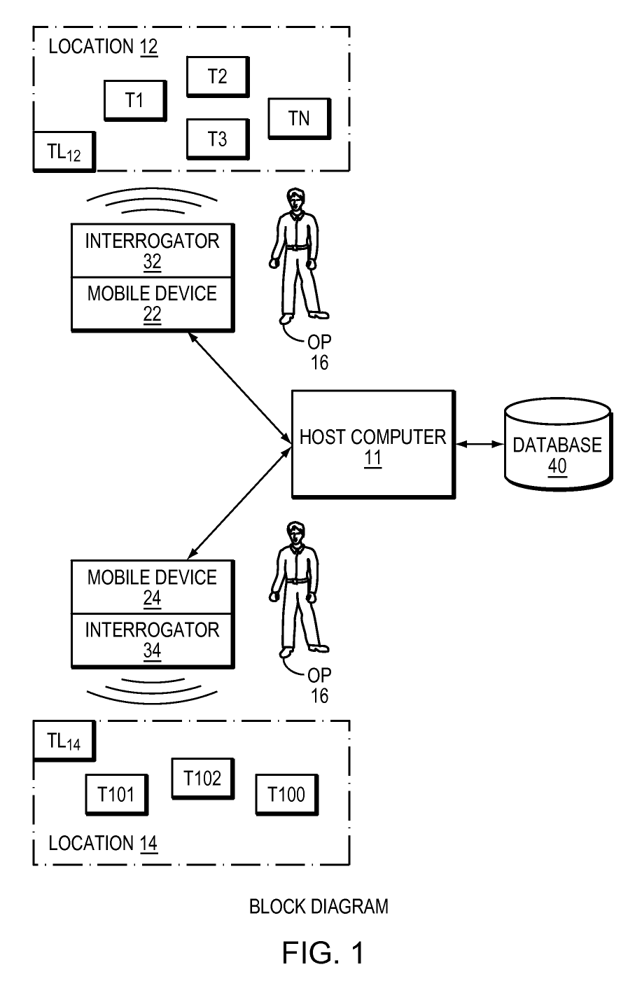

Referring to FIG. 1, in one embodiment, a retail or wholesale site 10 has an inventory system according to an embodiment of the invention. The retail or wholesale site has a number of locations, which are depicted by exemplary locations LOCATION 12 and LOCATION 14. There may be any number of locations, for example, tens or hundreds of locations in a particular retail or wholesale site. The locations may be grouped categorically and/or hierarchically such that a location may include several sub-locations as a grouping.

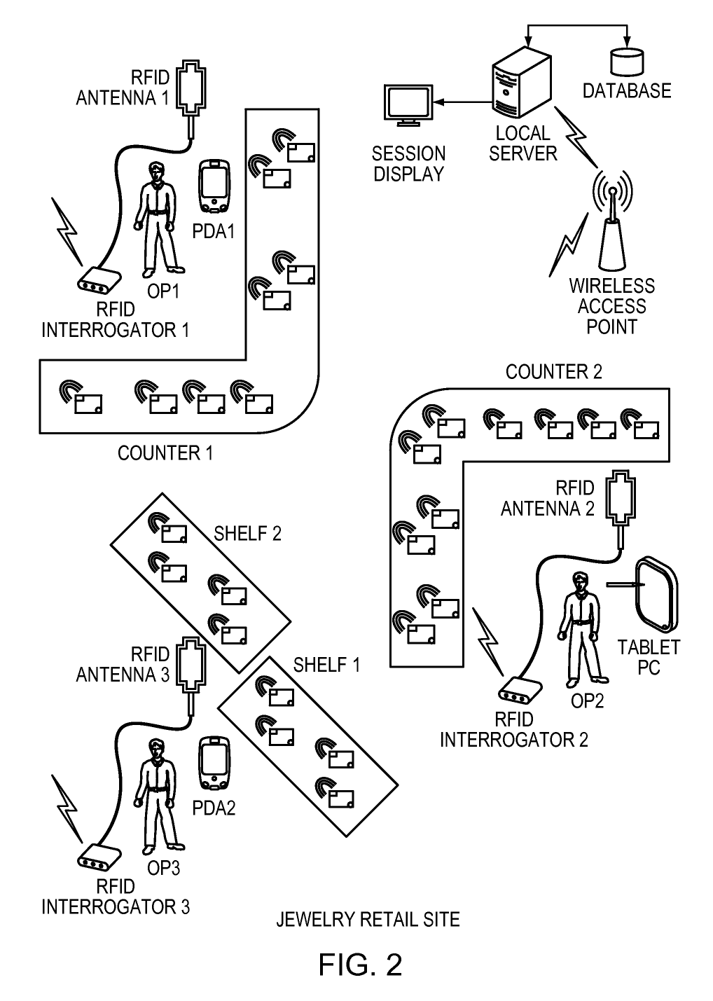

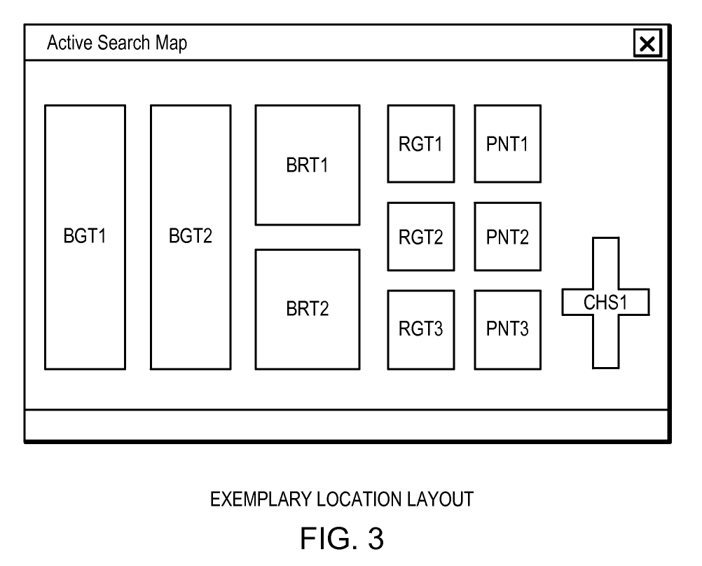

Referring briefly to FIG. 2, in one exemplary implementation in a jewelry store, locations include counters (e.g., counter 1, counter 2) and shelves (e.g., shelf 1, shelf 2). Referring briefly to FIG. 3, in another exemplary embodiment, locations within a site may be displayed on a location layout screen display, such as that shown. This screen display shows two bangle tray locations (e.g., BGT1 and BGT2), two bracelet tray locations (e.g., BRT1 and BRT2), three ring tray locations (e.g., RGT1, RGT2, RGT3), three pendant tray locations (e.g., PNT1, PNT2, PNT3), and one chain stand location (e.g., CHS1). It should be understood that these locations are exemplary, and may depend on the configuration of the retail or wholesale site.

Referring again to FIG. 1, each location 12, 14 may have some number of inventory items, which each have associated RFID transponders. The RFID transponders are shown as exemplary transponders T1, T2, T3 . . . TN, . . . T100, T101, T102, and so on. There may be any number of RFID transponders, and at some retail or wholesale sites, there may be hundreds, thousands, tens of thousands, or more. The RFID transponders T1 . . . T102 respond to a radiation signal (e.g., a radio signal) with information, which information includes a unique identifier.

Any suitable RFID transponders may be used, with any suitable technology. In some embodiments, RFID transponders from Sokymat SA (now part of Assa Abloy ITG) may be used, such as 13.56 MHz HF, ISO-15693 compliant transponders. Transponders are also available from UPM Raflatac and Alien Technology.

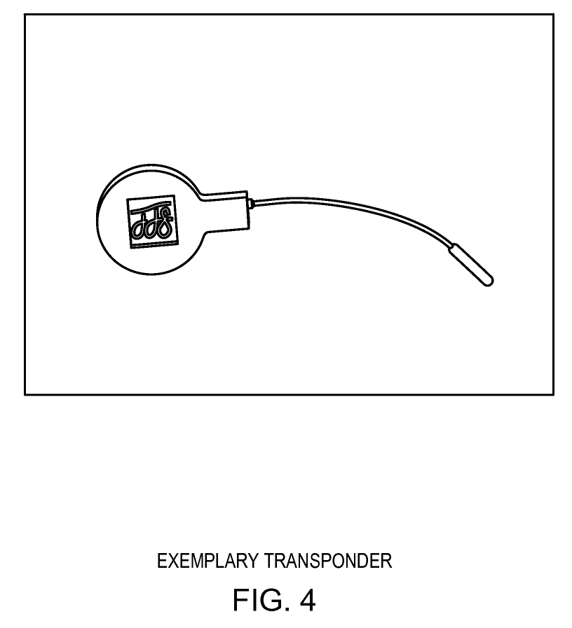

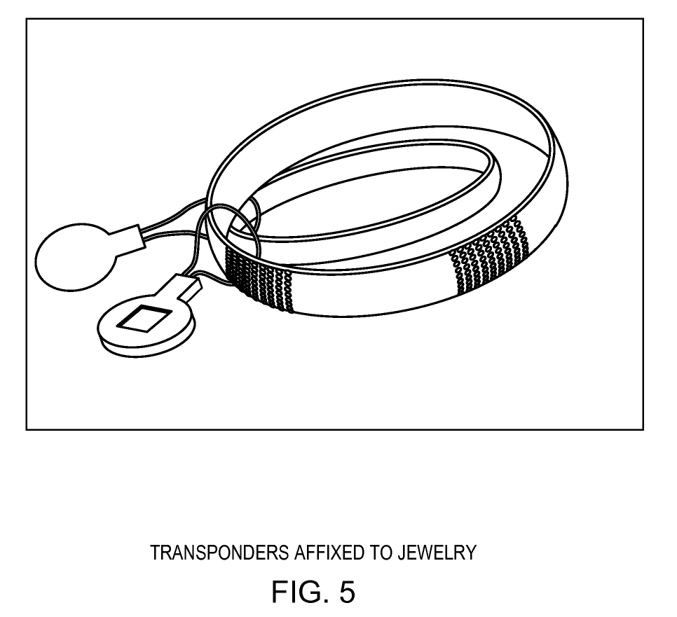

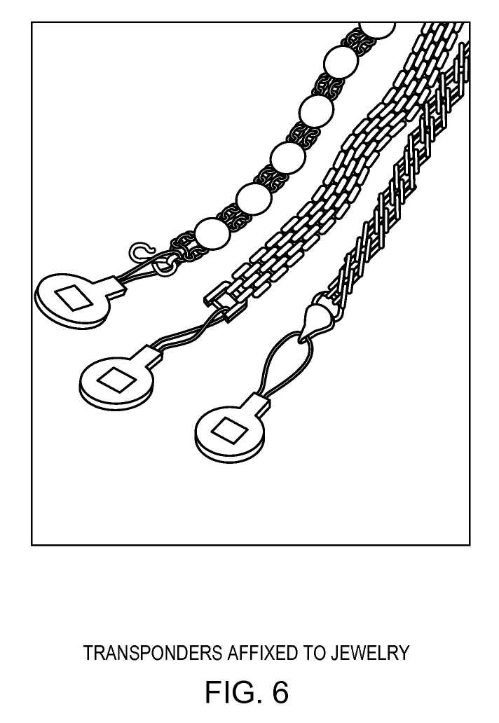

As an example, if the retail or wholesale site is a jewelry store, each item may be an item of jewelry, and the RFID transponder may be secured to the item with a tamper-proof feature, such that an RFID transponder ceases to respond to interrogations if it is tampered with. Referring briefly to FIG. 4, an exemplary RFID transponder is shown. Referring briefly to FIG. 5, an exemplary RFID transponder is shown attached to an item that is jewelry. Referring to briefly to FIG. 6, exemplary RFID transponders are shown attached to jewelry items that are bracelets.

The electronics of the transponder are inside the casing. In some embodiments, the transponder includes a portion that allows it to be attached to an object and that will render the RFID transponder inoperable if the transponder is tampered with or if it is detached from the object. In other implementations, tampering with the transponder will cause it to provide a different response to an RFID interrogator. Consider, for example, an instance in which a transponder is removed from a valuable piece of jewelry (allowing the piece to be removed from the store) and reattached to a less-valuable item in an attempt to fool the system into thinking the valuable piece is present. In such a case, the transponder may respond to an interrogator with a signal indicating it has been removed. An attendant is then alerted to the particular piece in question and can analyze it further to determine if it is genuine or a less-valuable copy. Using such tamper-evident tags allows an attendant to rapidly interrogate an entire case containing dozens (or even hundreds) of items and receive a list of items that may have been altered, stolen or replaced.

Referring again to FIG. 1, in some embodiments, each jewelry article is weighed and its weight associated in the system with the corresponding transponder. In some such embodiments, each jewelry article has a set of identifying attributes (e.g., brand, article type, supplier, color, metal, stone, karat, etc.) which are stored in the system by a system operator/administrator.

In some embodiments, the jewelry article may be weighed with the corresponding transponder attached. In such cases, the tare weight of the transponder is known with a very high degree of accuracy (e.g., within 1/1000^{th} of an ounce) and the weight of the jewelry item may be calculated by subtracting the item. In other cases, the transponder may be attached after weighing the jewelry and a total weight calculated. Having a total weight of the jewelry item and its associated transponder allows rapid identification of individual pieces by weight and transponder independent of one another, thus providing an additional security check.

For example, a display case may contain 125 pieces of jewelry, each having its own transponder attached. Further, the expected weight of all the transponders that should be in the case is known to a very high degree of accuracy based on an inventory report. An attendant may then gather all 125 pieces from that display case and weight them in total, and, in some cases, interrogate the group with an RFID interrogation device, resulting in a listing of transponders present and a total group weight. Such an interrogation can be done at the same time (or about the same time) as the weight is determined in order to eliminate or minimize the risk that the collection is altered between weighing and interrogation (e.g., within five minutes). In such cases, two separate calculations provide information regarding the collection of pieces. First, subtracting the expected weight of all the jewelry items expected to be in the case from the aggregate weight should result in the number of transponders multiplied by the per-transponder weight. Second, subtracting the total expected weight of the transponders from the aggregate weight should result in the total weight of all the expected jewelry items for that case. A mismatch in either case indicates either a missing transponder, missing piece, tampered transponder (e.g., one of the two components of a transponder has been removed) or some combination of the above. From this data, the inventory system can determine if an item (or in some cases more than one item) is missing, which item (or items) are missing, and if any of the transponders have been tampered with. As a result, an attendant can gather inventory data rapidly for a large group of items using both weight and RFID and compare the results to an inventory database to determine if any items are missing.

Several transponders may be grouped, attached and associated to a single transponder that may be referred to as a Master Transponder. The Master Transponder that may be of a different color to help the operator distinguish it physically from the other tags. By grouping, attaching and associating numerous transponders to a single transponder, the operator need only read the Master Transponder to verify the presence of the associated transponders. This method helps reduce the time it requires an operator to read large quantities of transponders. This method is particularly useful in wholesale operations where large quantities of goods are maintained and handled in bulk.

Similarly, several transponders housed in a container or a cabinet may be grouped and associated to a single Master Transponder. This method is more reliable if the said container or cabinet is designed in such a way whereby it may be closed and sealed by use of the Master Transponder in order to ensure that the Master Transponder, if still intact, indicates the assumed presence of all its associated transponders. Again, by using a Master Transponder to indicate the presence of numerous associated transponders, the operator need only read the Master Tag to deduce the presence of all the associated transponder thus reducing the time it requires to perform inventory. This method is useful, for example, in retail locations where tagged items that are stored in a cabinet or a container have not been accessed since the last inventory check. If, for example, a container-housing a range of wedding bands remained unopened, indicated by the intact presence of the affixed Master Transponder, since the last inventory, then the operator may assume that all the transponders housed in the container and associated to the Master Transponder are present.

Each location may have one or more location tags. These are transponders that are placed at a location (rather than on a particular item) so that the system may determine the approximate or precise location of items. For example, a location tag may be placed in a case or a drawer. If, for example, an interrogation results in responses from a number of transponders including a location tag, it is likely that the items associated with the responding transponders are located near the location tag, particularly in implementations in which the interrogator and/or transponders are configured for communication only at close range, so that it is unlikely that a transponder will receive a response from a transponder at a different location. Exemplary location tags are shown as TL₁₂ and TL₁₄, and it should be understood that there may be one, two, or more location tags at a particular location. Locations may be designated by areas, or by containers. For example, different displays, cabinets, trays, etc. each may be considered a different location. It may be, in some circumstances, that the number and locations of multiple location tags identified may provide further detail that may be used to more specifically determine the location of an interrogator at a particular time, for example by triangulation, or as another example, by placing a location tag at various sub-locations within a location.

Referring back to FIG. 1, one or more human operators OP16, OP18 each have a mobile device 22, 24, which mobile device may be, may include, and/or may have an associated interrogator 32, 34. The interrogator 32, 34 may send signals to the transponders and receive their responses. The interrogators 32, 34 may include RFID readers and antennas.

Any suitable interrogators may be used, depending on the transponders used. In some embodiments, 13.56 MHz HF RFID interrogator devices for mobile computers from ACG GmbH (now part of Assa Abloy ITG) are used. In other embodiments, RFID interrogator devices for mobile computers are used such as those available from AWID, Inc. and FEIG Electronic GmbH. In some embodiments, mobile (wired and wireless) 13.56 MHz HF RFID interrogator devices available from FEIG Electronic GmbH are used.

Once more referring to FIG. 1, the mobile devices 22, 24 may have some processing functionality and may be, for example, PDAs or Tablet PCs, such as those available from Acer Inc. and Hewlett-Packard, although any suitable mobile device may be used. The mobile devices may be attached to or may contain attached RFID interrogators for performing interrogation operations. The mobile devices and/or the host computer may display updates of the inventory sessions by showing progress on a screen display. The mobile devices and/or the host computer also may provide the operators with audio/visual feedback to report on the progress of the session, and with instructions for the operators in the form of graphical, audio and/or textual messages. The host computer may provide audiovisual feedback to some or all operators and pertaining to the progress of some or all operators. Each mobile device may report audio and/or visual feedback and progress to a single operator (typically the immediate user) pertaining to that user's session.

One such visual feedback to assist the human operator(s) to efficiently perform inventory may come in the form of a dynamically changing location map. This location map may depict realistically the retail space in which there are transponders affixed to items. Then, with the use of different colors, the location map may indicate to the operator(s) what area they are currently reading, what area has been completed thus far and what area remains to be read or completed. For example, a green color may signify the area in which the operator is actively reading. Once the area has been completed whereby every transponder assigned to the said area has been read by the inventory reader, the color may switch to grey. A yellow color may signify all the areas wherein tags assigned to those locations have not been read yet. A red color may signify an area that has been read but in which some tags assigned to the said area remain unread. Furthermore, each specific location on the map may feature the number of tags remaining to be read, the number of tags read thus far, or any combination of information that is useful to the operator.

In some instances, the visual map may be annotated with text messages indicating the status of inventory at that location. For example, an area colored yellow (indicating the inventory has not been completed) may also include text indicating the number of expected items at that location, the last date and time inventory was performed at that location, and the operator ID of the person performing the previous inventory. Numeric messages may also be placed on or about the visual map indicating a preferred order in which to inventory the areas to minimize time and/or to direct the operator to the most expensive items first. In other embodiments, the specified list of sites to be inventoried may include only a subset of the stations due to the inventory being performed on behalf of a financier or investor that is only concerned with certain items.

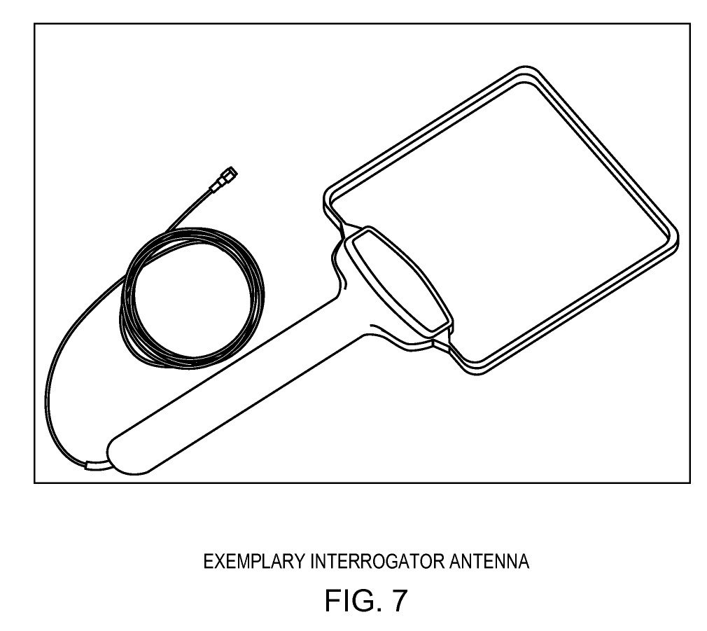

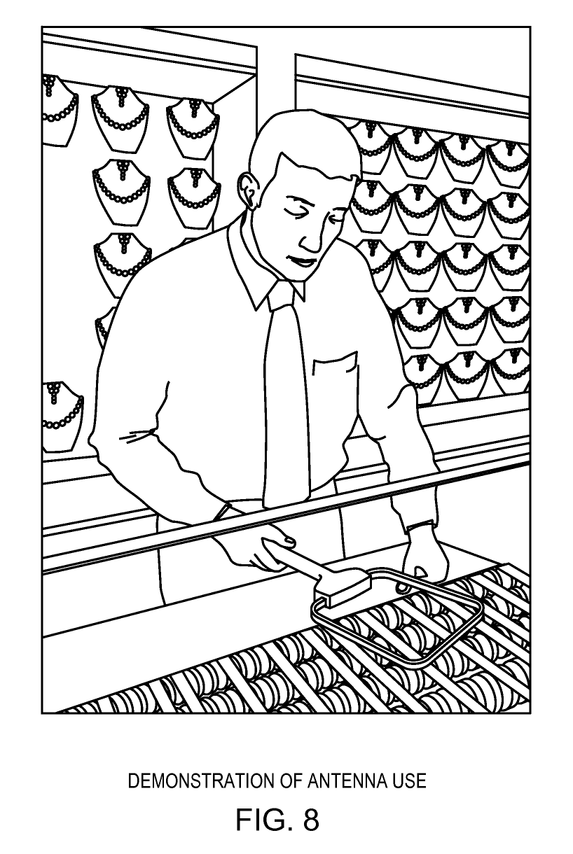

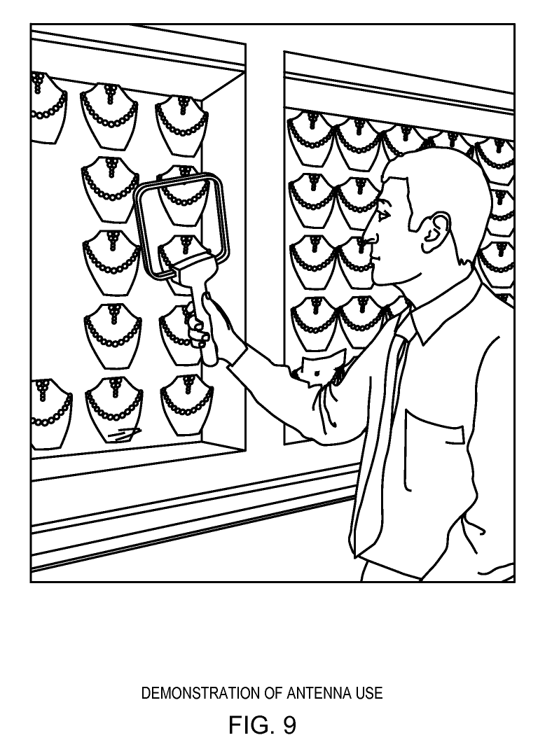

Referring briefly to FIG. 7, an exemplary antenna for an interrogator is shown. This antenna may be connected to an interrogator on a mobile device, and used to conduct close-proximity interrogations of transponders. Referring briefly to FIG. 8, a human operator facilitates interrogations of items by moving the antenna in close proximity to transponders affixed to items. Referring to FIG. 9, the human operator has moved the antenna from the case shown in FIG. 8 to an upright display. The interrogator now interrogates the transponders in the upright display and reports the results to the mobile device and/or host computer.

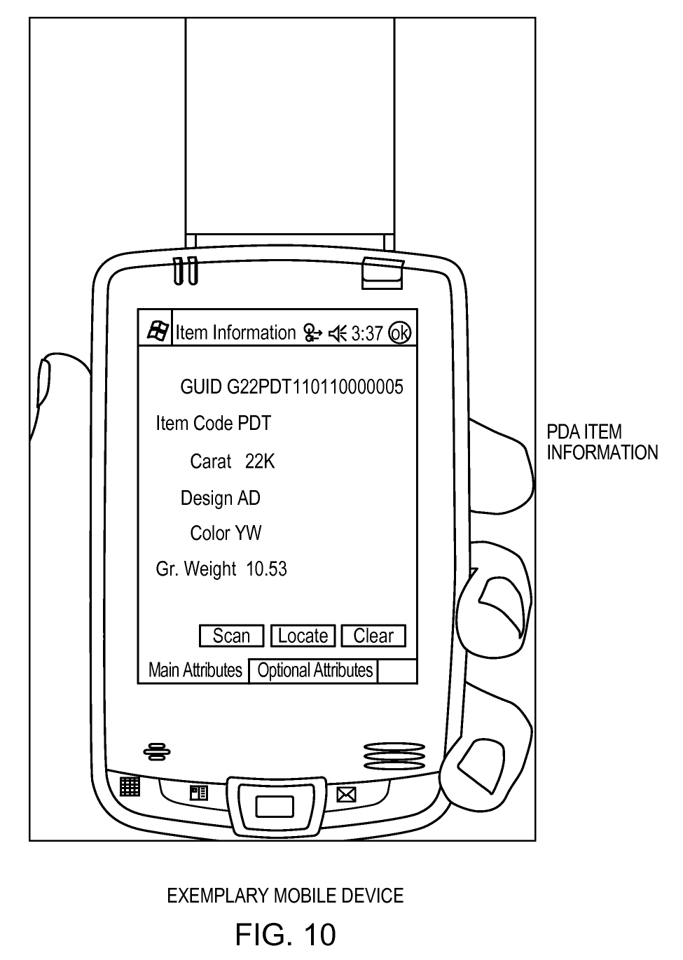

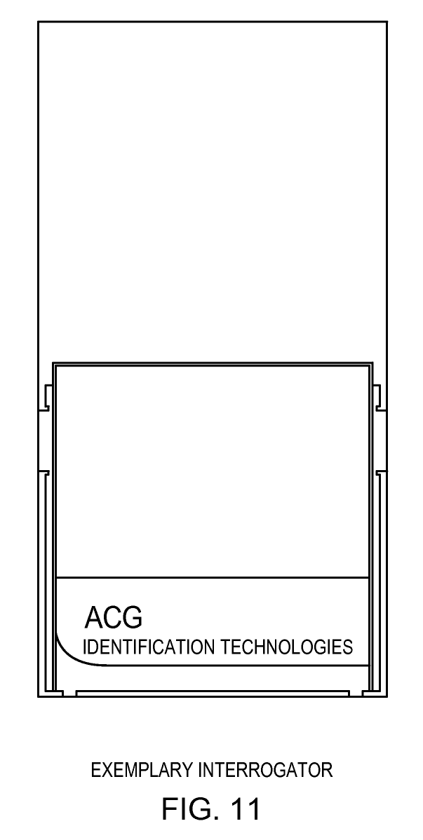

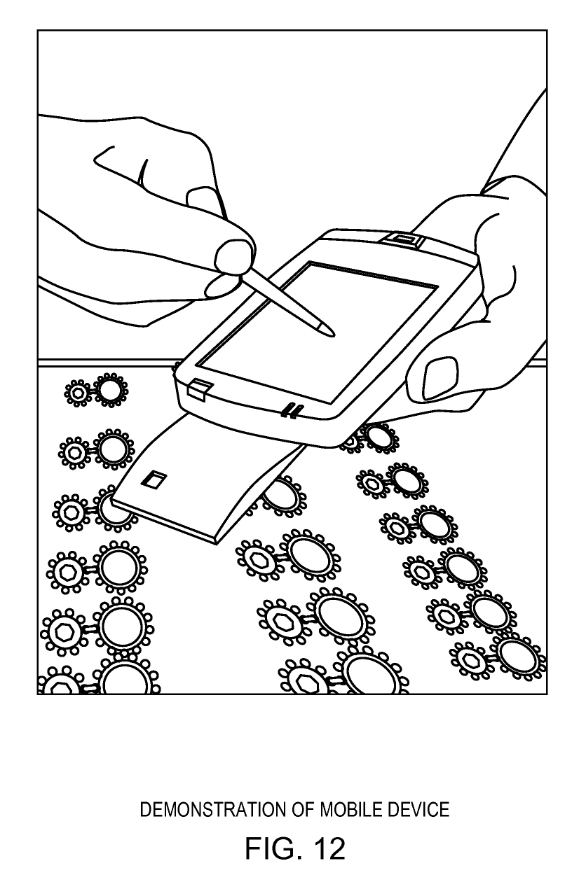

Referring to FIG. 10, an exemplary mobile device is shown, which is an iPAQ Personal Digital Assistant available from Hewlett-Packard. The display of the mobile device presents information about an item. Referring to FIG. 11, a reader such as that available from ACG GmbH is shown, which reader may be configured for use with the mobile device of FIG. 10. Referring to FIG. 12, the reader of FIG. 11 is shown held by a human operator and interrogating items in a display case.

Referring again to FIG. 1, the mobile devices 22, 24 are in communication with the host computer 11 over a computer network, such as a wireless network (e.g., 802.11 or Bluetooth) or a wired network (e.g., 802.3, serial, or USB).

Referring again to FIG. 1, the host computer 11 is in communication with a database 40. The database stores data about the items. The data may be stored in a relational database for fast and efficient storage and access. Different database implementations may be used, with associated cost and performance trade-offs. Suitable databases that may be used in various embodiments include but are not limited to PostgreSQL; Microsoft SQL Server Compact, Express, Standard, and Enterprise Editions; and VistaDB versions 2.1 or higher. The data model stores unique identifier information for each tagged item and each tagged location; current and historical location information for each tagged item; and an infinite number of attributes for each tagged item.

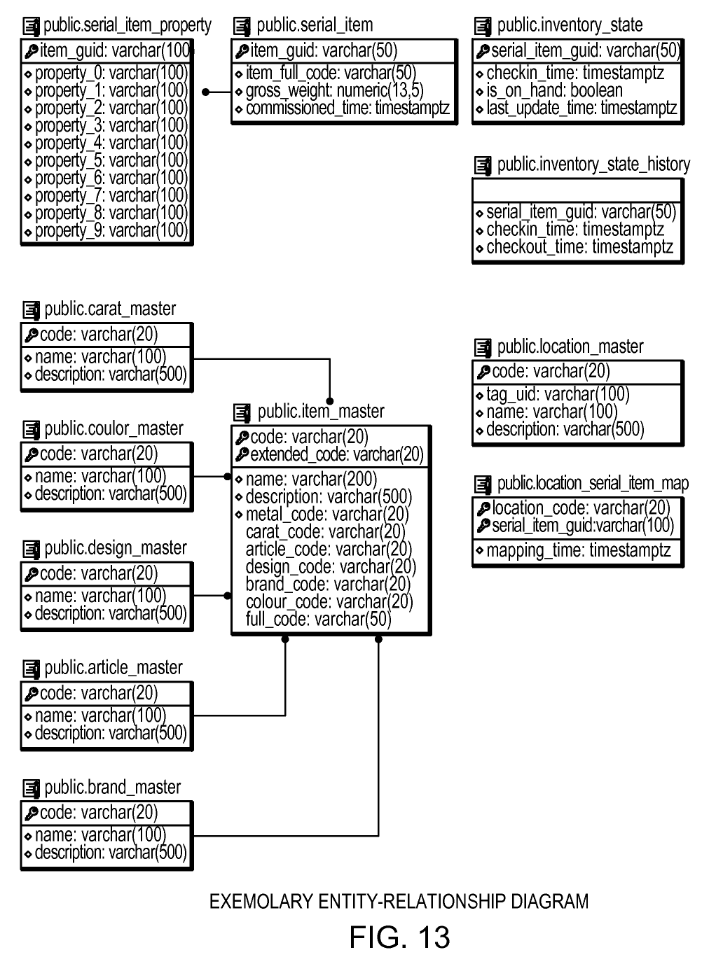

As an example, an Entity-Relationship diagram of an exemplary, simplified data schema is shown in FIG. 13. As shown in the figure, an item (as described in the item_master table) may have a code, an extended code, a description, and a flexible set of other attributes depending on the specific need of the retailer or wholesaler. The code is a unique reference that is used to group (or refer to) the primary attributes of an item (in this example, the carat code, the metal type, and the article type) and is used by the application to sort, group, and present data to users based on the grouping of their primary attributes. The extended_code is a unique reference that is used to group (or refer to) the secondary attributes of an item (in our example, the brand name, the color code, and the design type) and is used by the application to sort, group, and present data to the users based on the grouping of their secondary attributes and it is useful for pinpointing items with greater efficiency. Typically, the code and the extended_code are used in combination to form a full_code, which references all the defined attributes of an item. An item may have a name and a description and a set of other user-defined properties (in this example, 10 properties are allocated in the serial_item_property table). Typically, this information is provided when the user looks up an item based on its unique identifier or when the user performs a narrow or broad search for items based on one or a combination of the attributes and/or user-defined properties. The item may have a carat code, defined in the carat_master table. Further, an item may be defined by its inventory state as described by the inventory_state table. The inventory_state table in this example contains items that are currently present within the retail or wholesale location and shows the time the item was received into the site and when it was last interrogated successfully (the last_update_time field). Similarly, the inventory_state_history table stores previous inventory states of the item and is used for reporting, auditing, and tracking and tracing purposes. The location_master table contains a listing of configured locations within the retail or wholesale site environment. The location of each item may be determined by looking up the unique identifier of the item in the location_serial_item_map table and retrieving an associated location code.

Referring again to FIG. 1, in some embodiments, the interrogators 32, 34 on the mobile devices 22, 24 constantly interrogate nearby RFID transponders T1 . . . T102, and store the information received. As the human operators OP16, OP18 move about the retail or wholesale site, the mobile devices scan the transponders affixed to items in the places where the items are located. Periodically, upon request or automatically, the mobile devices communicate to a host computer a list of unique identifiers that were detected by that mobile device since the last communication with the host computer. The list of identifiers may be collected by the host computer and compared to expected identifiers in the database 40. Each identifier may be associated with a set of attributes in the data store. Each identifier may be associated with a location identifier in the data store. This location, typically, is also associated with one or more identifiers. The host computer 11 may aggregate and filter identifier data and discard duplicates or unknown identifiers. The host computer 11 may update the location associated with a transponder and/or may signal that a change in location has occurred.

Still referring to FIG. 1, the host computer 11 may provide a signal to a mobile device and/or an interrogator to provide audio and/or visual feedback to its human operator to indicate whether all transponders at a particular location have been interrogated successfully. The host computer 11 may provide a signal to a mobile device to provide audio and/or visual feedback to its human operator to indicate whether an operator has spent too much time in a location without any additional results, additional locations to which the operator may move, and other actions that may be taken. The host computer may provide data to the mobile device and/or an administrator to provide a view of the accounted-for identifiers. The view may be grouped by the items' associated attributes to facilitate the process of finding missing or unread RFID transponders.

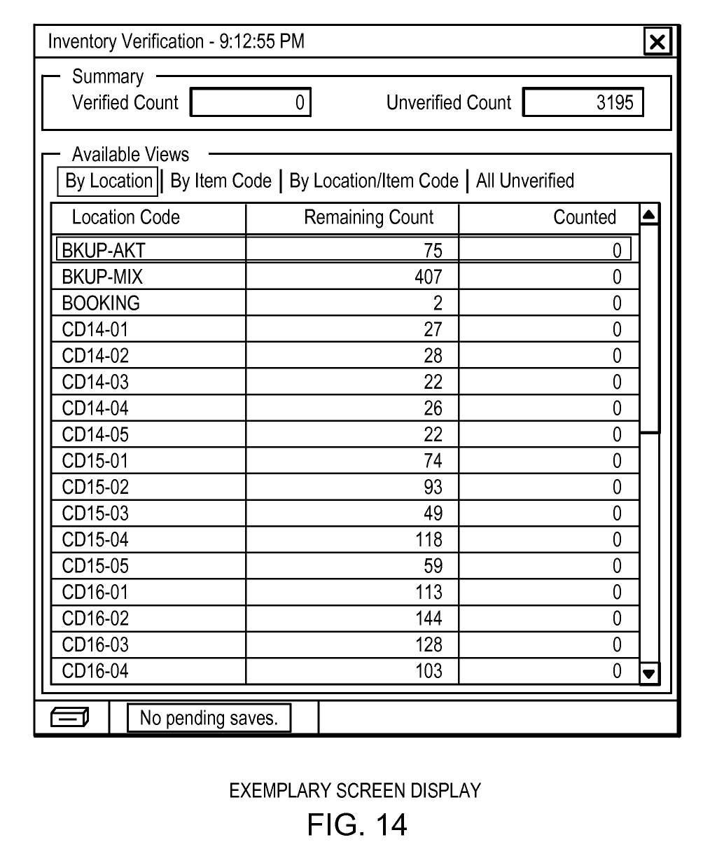

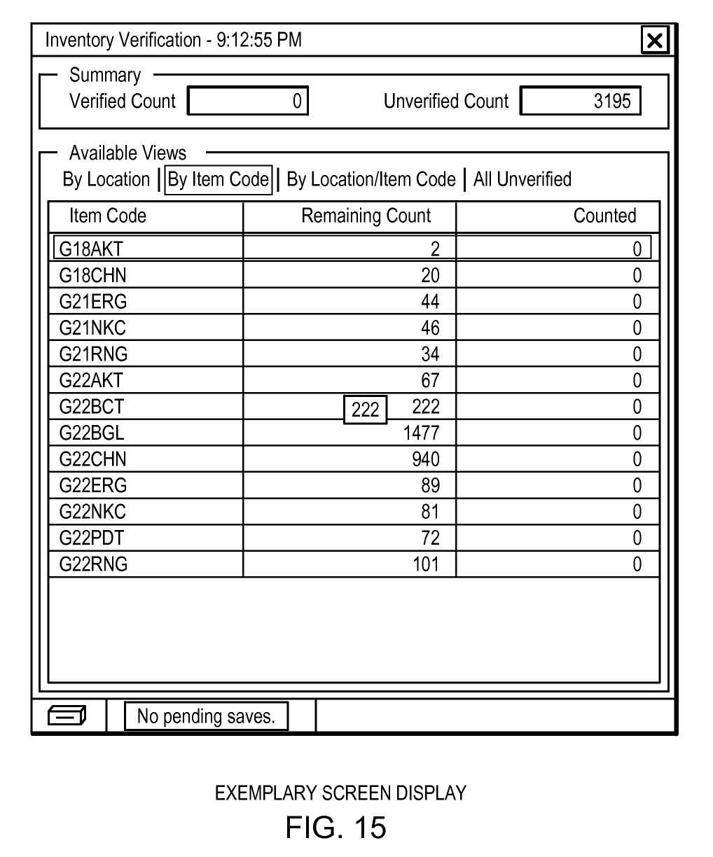

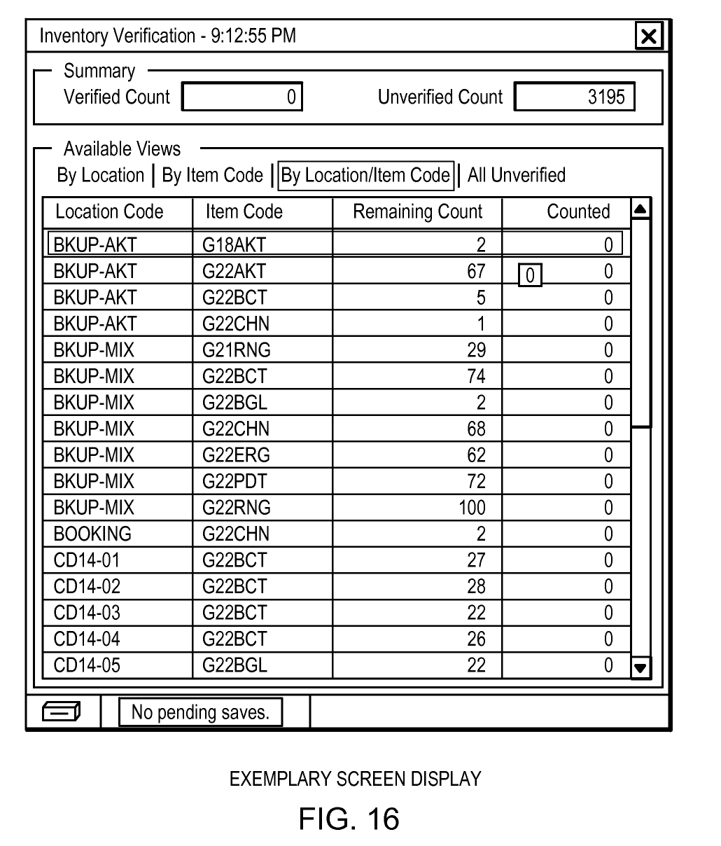

Referring to FIGS. 14-16, in one embodiment, a system administrator (and/or a user of a mobile device) may display data about the inventory according to a custom configuration. This may include defining a set of data views that group data according to one or more of: item count by location (FIG. 14), item count by code (FIG. 15), item count by location/code (FIG. 16), and such other views including but not limited to item count by karat, item count by weight and/or item count by any attribute or combination of attributes.

Referring again to FIG. 1, once data is loaded, each operator may be assigned a mobile device/interrogator to move about the retail or wholesale site. The operator may scan a location tag and items within that location. As transponders associated with items are scanned and buffered by each mobile device/interrogator, data is sent back to the host computer. In some embodiments, the host computer collects data and discards duplicate item tags that were previously read (by comparing the new batch of data with the system cache). This feature may enhance system performance.

Once duplicates are filtered, they may be forwarded to another filter that cleans the data as follows. If an item tag was interrogated and the current active location being scanned does not match the associated location of the item tag then the system is updated with the actual location, thus correcting the system view in the event a human user mistakenly misplaced the item. If a location tag wasn't scanned (or not used at all), then the system sorts the incoming data by timestamp and sorts it by location, then compares both sorted lists and tries to eliminate or flag misplaced tags by deducing that the majority of unique tag identifiers that were sorted by timestamp belonged to the same location in the system, and that a few of the tags appeared out of order because the system showed the item tags belonged to a different location than the majority of the item tags. If an unidentified item tag was scanned, then it is flagged as an exception. Once the data is filtered and cleaned then the views on the PC screen are updated accordingly by reducing the number of remaining counts for each grouped entry and increasing the number of accounted items for each grouped entry.

In some embodiments, on arrival of each batch of data from a reader, the system produces a ping sound as a positive acknowledgement to the human operator(s) that new data is being processed.

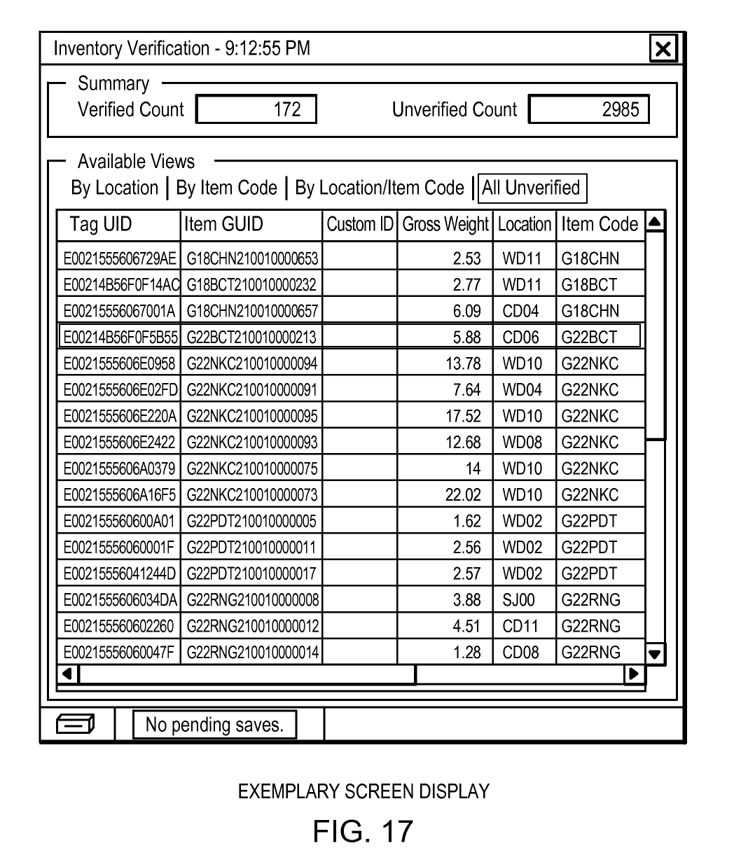

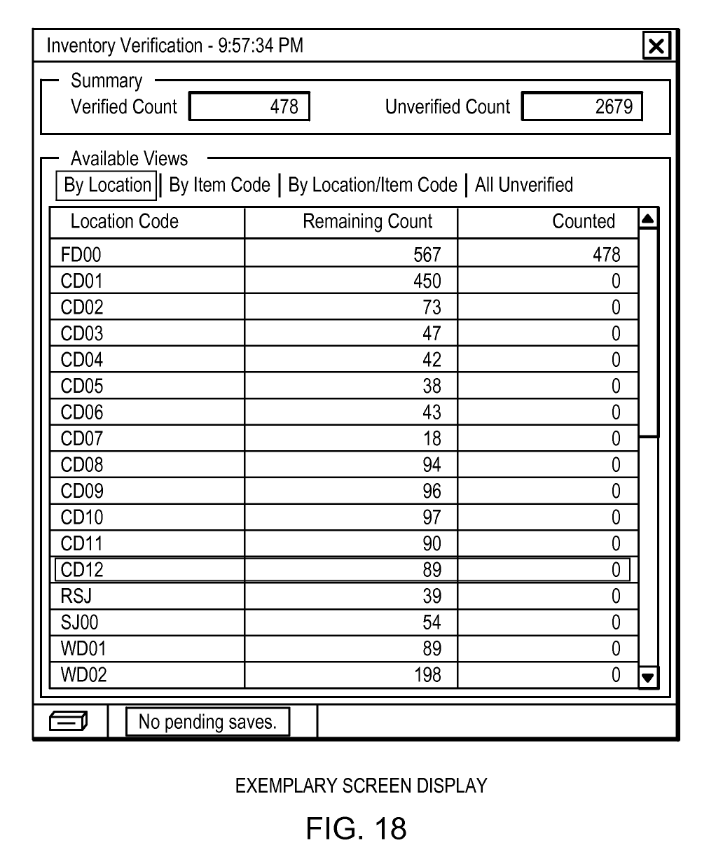

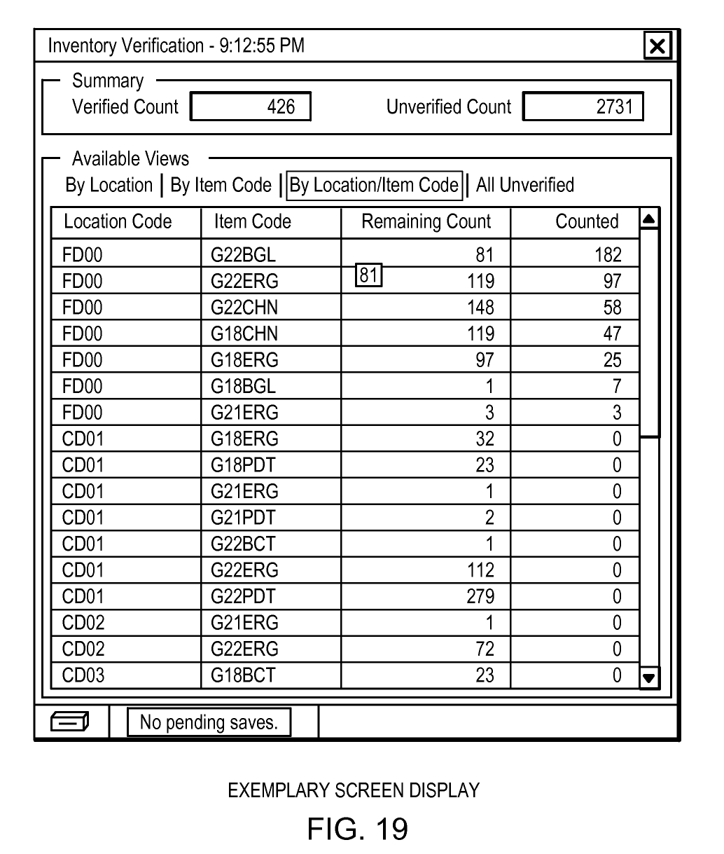

Referring to FIG. 17, the display on a host computer or mobile device may provide information about inventory items not yet accounted for. For a session already in progress, different groupings of data may show accounted and remaining items. For example, the figure shows all unverified items, with an unverified count of 2985 and a verified count of 172. Referring to FIG. 18, a view by location shows locations that have not yet been accounted for. This allows an operator to determine which locations have yet to be scanned. Referring to FIG. 19, a display of unverified items by location and item code allows a human operator to look for unaccounted items based on their type, given the location in which they should be found.

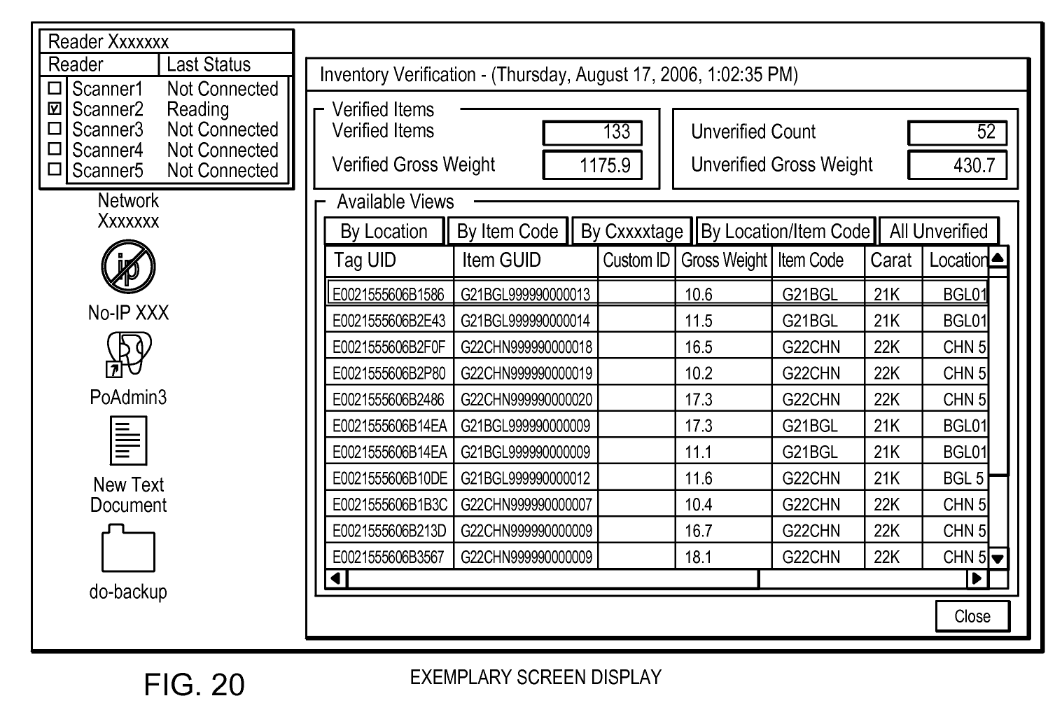

Referring to FIG. 20, a live inventory scanning session is shown in which several operators are involved. The “Reader Control” top-left window has 5 rows, with one row for each scanner. Since only a few items, namely 52, remain to be scanned according to the main window, only one operator, namely Scanner2, is active, as shown by the Reader Control window (the other four operators are highlighted in red to show that their mobile devices are offline).

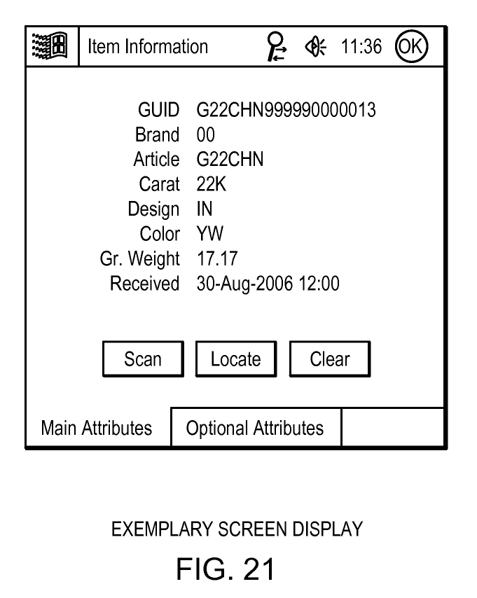

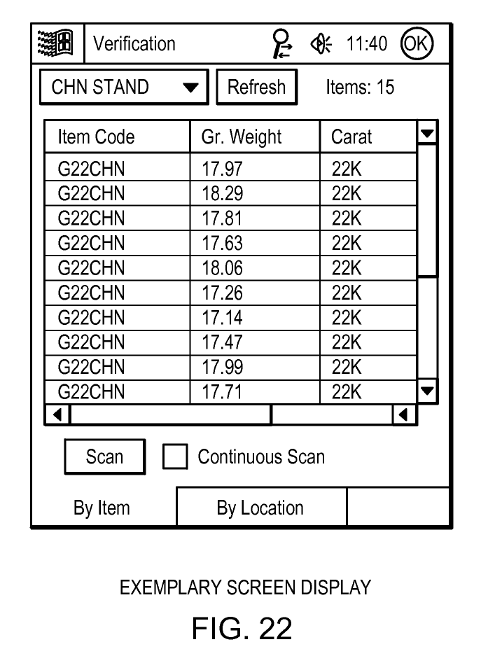

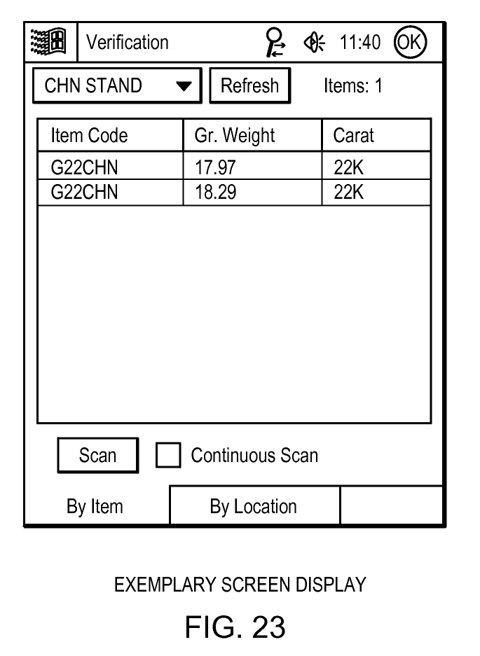

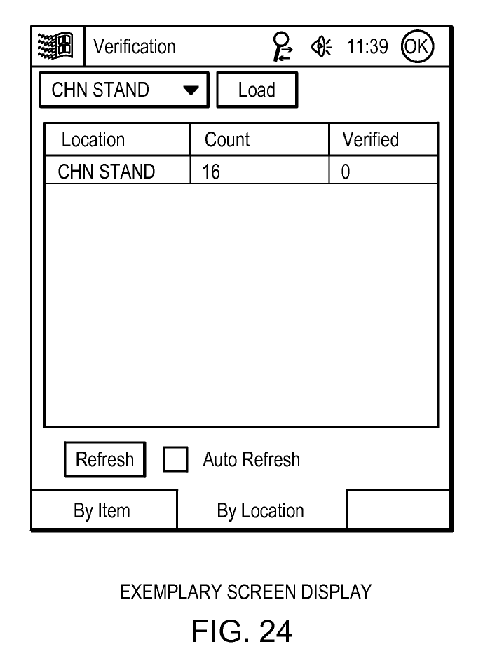

Referring to FIG. 21, a mobile device display shows information about an item. Referring to FIG. 22, a list of unverified inventory items is shown for a particular location on a mobile device display. Referring to FIG. 23, a number of items from FIG. 22 have been found, and the remaining items to be found, precisely 2, at the specified location are listed on the mobile device display. Referring to FIG. 24, the number of accounted items and the number of unaccounted items at a particular location are shown on the mobile device display.

In some embodiments, the system also monitors the rate of arrival of tags from each reader. Once a reader has not detected items for a configured amount of time then the system issues an audio message instructing that specific operator to proceed to another location. This feature may enhance operator time performance and scan efficiency.

In some embodiments, once a first pass across the assigned locations is completed by each operator, the operators proceed to a second pass, looking for items that were missed during the first pass. The goal with a two-step procedure is to perform a productive and efficient first pass, typically accounting between 95-98% of the total items, and then perform an efficient second pass by using the grouping/sorting/guiding features of the system to identify the remaining items. For example, some retail or wholesale sites may group their jewelry items by carat, and if the data is grouped by carat in the system, then the search for missing items is optimized for that site. Other retail or wholesale sites may group their jewelry items by supplier and thus would configure the system to search for missing items by supplier, and so are able to search more efficiently. By providing the operations with the ability to quickly see on their device the items that are missing, and the last location of those items, a system enables operators to quickly search, find, and account for items that remain unaccounted for after the first pass.

In some embodiments, particularly useful for larger installations, the data received by the mobile device is filtered at the host computer and then updates are sent to the mobile device, however, only updates of accounted items from the human operator using a specific RFID interrogator will be sent to the corresponding mobile device. For example, if operator John is operating RFID interrogator A, and mobile device X and operator Mary is operating RFID interrogator B, and mobile device Y, then data from RFID interrogator A is collected, filtered, cleaned, and propagated to PDA X only, and similarly, data from RFID interrogator B is collected, filtered, cleaned, and propagated to PDA Y only. In such an embodiment, there may not be spoken audio feedback but there may be an audible ping and visual effects produced by the mobile device to instruct the operator to proceed to another location.

1. A method for conducting an inventory of items at a site, comprising:
moving, by a human operator, a mobile device to a first location within the site, the mobile device comprising an RFID interrogator;
interrogating, by the RFID interrogator, RFID transponders affixed to inventory items and one or more transponders placed at specified locations within the retail or wholesale site;
providing, by the mobile device, a signal to the human operator upon occurrence of one or more of the following conditions:
(i) items previously at the first location are missing;
(ii) items previously at another location are present at the first location; and
(iii) all items at the first location have been accounted for.

2. The method of claim 1, wherein the method further comprises receiving responses to the interrogation by the RFID interrogator, each response comprising a unique identifier associated with the responding RFID transponder, and discarding duplicate and unknown identifiers.

3. The method of claim 1, further comprising, upon providing the signal that all items at that location have been accounted for, moving the mobile device and the RFID interrogator when it is a separate mobile unit to a second location within the retail or wholesale site, and repeating the interrogation and providing steps for the second location.

4. The method of claim 1, wherein the first location may be a display fixture, cabinet, wall display, box, drawer, or tray.

5. The method of claim 1, further comprising providing, by the mobile device, a display of the number of items not yet accounted for and a display of the number of items already accounted for.

6. The method of claim 5, wherein each of the items is assigned a set of attributes, and the attributes of items not yet accounted for are displayed to the human operator.

7. The method of claim 6, wherein the items are jewelry, and the attributes comprise one, two, or more attributes selected from the set of: brand, article type, supplier, color, metal, stone, design, and karat.

8. The method of claim 1, wherein the RFID transponders affixed to the items are tamper-proof.

9. The method of claim 1, wherein the RFID transponders affixed to the items are tamper-evident.

10. The method of claim 1, wherein the mobile device is in communication with a central software host system.

11. The method of claim 1, further comprising moving, by human operators, two or more mobile devices to different locations within the retail or wholesale site, and wherein each human operator conducts an inventory for a portion of the retail or wholesale site.

12. The method of claim 1 wherein the mobile device further comprises a visual display, and the visual display provides a visual representation of the site.

13. The method of claim 12 wherein the visual representation of the site comprises an indication of a current location of the mobile device in reference to the visual representation of the site.

14. The method of claim 13 wherein the visual representation of the site further comprises an indication as to an interrogation status of a plurality of locations about the site.

15. A method of performing inventory management, the method comprising:
determining a weight of a plurality of items at a first time;
affixing an RFID transponder having a known weight to each of the plurality of items:
determining, at a second time, a total weight of a subset of the plurality of items having the RFID transponders affixed thereto;
calculating a weight difference between the weight at the first time and the weight at the second time;
determining, based on the calculated weight difference, possible combinations of items missing at the second time.

16. The method of claim 15 wherein the possible combinations include items having the RFID transponders affixed thereto and items having the RFID transponders removed therefrom.

17. The method of claim 15 further comprising:
interrogating the RFID transponders at a time proximate to the second time;
comparing results of the interrogation to a listing of the plurality of items, and based thereon, compiling a list of missing RFID transponders;
comparing the list of missing RFID transponders to the possible combinations of items missing at the second time; and
determining items missing from the plurality of items.

18. A system for verifying an inventory of items at a site, the system comprising:
an RFID interrogator;
RFID transponders affixed to inventory items and one or more transponders placed at specified locations within the retail or wholesale site;
wherein RFID interrogator is in communication with a central software host system, and is configured to signal to a human operator upon occurrence of one or more of the following conditions:
(i) items previously at the first location are missing;
(ii) items previously at another location are present at the first location; and
(iii) all items in that location have been accounted for.

19. The system of claim 18 further comprising a mobile telecommunications device and wherein the mobile telecommunications device comprises the RFID interrogator.

20. The system of claim 18 wherein the RFID transponders are tamper-proof.

21. The system of claim 18 wherein the RFID transponders are tamper-evident.
